(19) United States
(12) Patent Application Publication
(10) Pub. No.: US 2011/0258295 A1
(43) Pub. Date: Oct. 20, 2011

(54) INFORMATION PROCESSING TERMINAL AND METHOD THEREOF

(75) Inventors: Takeshi SAITO, Tokyo (JP); Kotaro ISE, Saitama-ken (JP); Tooru KAMIBAYASHI, Kanagawa-ken (JP); Hideki TSUTSUI, Kanagawa-ken (JP); Satoshi ITO, Tokyo (JP)

(73) Assignee: KABUSHIKI KAISHA TOSHIBA, Tokyo (JP)

(21) Appl. No.: 13/171,385

(22) Filed: Jun. 28, 2011

Related U.S. Application Data
(63) Continuation of application No. 11/505,427, filed on Aug. 17, 2006, now abandoned.

(30) Foreign Application Priority Data
Aug. 17, 2005 (JP) 2005-236757

(51) Int. Cl. G06F 15/16

(52) U.S. Cl. 709/219

(57) ABSTRACT

An information processing terminal connectable to a WWW (World Wide Web) server via a public network includes a storage unit that stores content data including image information or sound information with identification information of the content data, an acquiring unit that acquires identification information of content data from the WWW server, a retrieving unit that retrieves content data corresponding to the identification information acquired by the acquiring unit from the storage unit, and a presenting unit that presents the content data retrieved by the retrieving unit.

### CROSS-REFERENCE TO RELATED APPLICATION

This application is a continuation of U.S. application Ser. No. 11/505,427, filed on Aug. 17, 2006, which claims priority from Japanese Patent Application No. JP-2005-236757, filed on Aug. 17, 2005, the entire contents of which are incorporated herein by reference.

### BACKGROUND OF THE INVENTION

1. Field of the Invention

The present invention relates to an information processing terminal, an information processing method and an information processing program product, particularly to an information processing terminal, an information processing method, and an information processing program product for use in viewing content data including image information and sound information.

2. Description of the Related Art

In recent years, there is a bulletin board system (BBS) which is a service widely available as an application utilizing public networks such as the Internet. The bulletin board system is a service that is offered in the form of a Web site on the Internet. A user makes access to a Web site that offers a bulletin board system, and posts a message freely thereon to share information. Here, posting a message on the bulletin board system is implemented by sending and storing text data and the other data to memory in a bulletin board system server which is a WWW (World Wide Web) server.

In such use of the bulletin board system on the Internet, it is demanded that text information as well as content data including video information and sound information, for example, are shared on the bulletin board system to allow individual users to view them. More specifically, for example, when a user desires to make a comment on a program broadcast on TV and to make review on a commercially available CD, the user sends content data of that TV program and CD to a bulletin board system server with the comment and the review. Then the data thereof is distributed from a bulletin board system server to another user when requested. With this scheme, individual users can share and view the content data thereof. So it makes possible for users to have an active exchange of opinions.

However, for example, when the content data of the broadcast TV program, the commercially available CD and so on is stored in the bulletin board system server on the public network such as the Internet, it is sometimes necessary to clear copyright issue and other procedures related to the content data thereof. On this account, depending on content data, it is sometimes difficult that content data is sent via the public network and stored in the bulletin board system server to allow other users to view it.

In addition, even though a user is able to send and store content data in the bulletin board system server via the public network, limitations are imposed on sending and receiving content data via the public network when the size of content data is large, for example, because of a large communication load on the public network or a large load on the memory in the bulletin board system server.

As described above, in the related art, content data itself is sent and received with a WWW server via a public network. Therefore, it has a problem that a user might not be able to view content data depending on the types or the size of content data.

### SUMMARY OF THE INVENTION

The invention has been made to solve the problem of the related art. An object is to provide an information processing terminal which allows a user of a WWW server to view content data via a public network without sending and receiving content data itself with a WWW server, an information processing method and an information processing program product.

According to one embodiment of the present invention, there is provided a novel information processing terminal connectable to a WWW (World Wide Web) server via a public network comprising: a storage unit configured to store content data including image information or sound information with identification information of the content data; an acquiring unit configured to acquire identification information of content data from the WWW server; a retrieving unit configured to retrieve content data corresponding to the identification information acquired by the acquiring unit from the storage unit; and a presenting unit configured to present the content data retrieved by the retrieving unit.

As described above, according to the information processing terminal of an embodiment of the invention, identification information of content data is acquired from the WWW server via the public network, and the corresponding content data is retrieved from the storage unit of the information processing terminal based on the identification information. Therefore, content data can be viewed without sending and receiving content data via the public network.

### BRIEF DESCRIPTION OF THE DRAWINGS

FIG. 1 is a block diagram showing a network system including an information processing terminal according to a first embodiment of the invention;

FIG. 2 is a block diagram showing the information processing terminal according to the first embodiment of the invention;

FIG. 3 is a flowchart showing the operation according to the first embodiment of the invention;

FIG. 4 is a diagram showing exemplary display of a bulletin board system;

FIG. 5 is a diagram showing an exemplary content list table according to the first embodiment of the invention;

FIG. 6 is a diagram showing an exemplary selection screen of a display device according to the first embodiment of the invention;

FIG. 7 is a diagram showing an exemplary method of acquiring identification information according to the first embodiment of the invention;

FIG. 8 is a diagram showing an exemplary method of displaying a hyperlink according to the first embodiment of the invention;

FIG. 9 is a diagram showing exemplary display of content data according to a second embodiment of the invention;

FIG. 10 is a block diagram showing the configuration of an information processing terminal according to a third embodiment of the invention;

FIG. 11 is a diagram showing the configuration of a network system including an information processing terminal according to a fourth embodiment of the invention; and

FIG. 12 is a block diagram showing the configuration of the information processing terminal according to the fourth embodiment of the invention.

### DETAILED DESCRIPTION OP THE INVENTION

Hereinafter, embodiments according to the invention will be described.

### First Embodiment

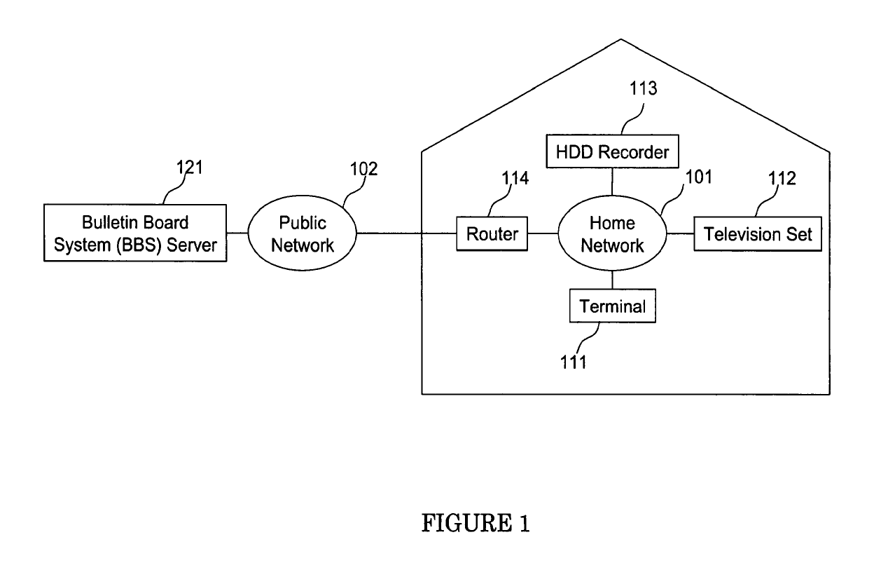

FIG. 1 is a block diagram showing a network system including an information processing terminal according to a first embodiment of the invention (hereinafter, called a terminal).

In the network system according to the first embodiment, a terminal 111, a television set 112, and a HDD (Hard Disk Drive) recorder 113 are connected to one another through a home network 101 which is a local network. In addition, the home network 101 is connected to a public network 102 through a router 114, and a bulletin board system server 121 is connected to the public network 102.

In addition, here, the local network is a network that is constructed by allowing sending and receiving data between terminals which exist in a limited area such as a home and a single building. In addition, the public network is a network that is constructed by interconnecting a plurality of local networks, such as the Internet.

The HDD recorder 113 is a storage device that stores content data. Here, content data is considered to be a broadcast TV program. In addition, the HDD recorder 113 stores such a TV program with identification information which identifies the TV program.

Here, it is sufficient that identification information is information that can specify a TV program. For example, TV program information used in an EPG (Electronic Program Guide) may be used as identification information, or VIDEO Plus+ numbers may be used as identification information. Alternatively, content IDs defined by the Contents ID Forum (cIDf) may be used. Furthermore, when a manufacturer offers a storage device for storing TV programs and that manufacturer's storage device is provided with a function adding and storing its original identification information in recording a TV program, that identification information may be used.

In addition, a unit of assigning identification information is not necessarily in units of programs. For example, identification information may be assigned separately to each section in a program, or may be assigned at a predetermined time interval.

In addition, desirably, the HDD recorder 113 is a so-called “multi-channel full time recorder”. More specifically, for example, such a device is preferable that can record programs for a long time such as multiple channels of ground wave broadcasting (or BS broadcasting, digital broadcasting, CATV, Internet distributed contents, etc.) for 24 hors or longer, and can allow a user to view any recorded program at anytime.

The bulletin board system server 121 is a server that offers a bulletin board system service which all subscribers (or, members of a certain membership community) can freely post messages. The bulletin board system server 121 receives and stores document data posted on a bulletin board system by a user, displays it on the bulletin board, and allows other users to see it.

A hyperlink is a method of sharing and viewing content data including image information and sound information on the bulletin board system. The hyperlink is a character string that indicates location information about other documents and images. The hyperlink is embedded in a document. Generally, when a user of a bulletin board system clicks a hyperlink on the bulletin board, a bulletin board system server displays content data indicated by the hyperlink on a user's terminal. According to the related art, since content data indicated by the hyperlink exists on the bulletin board system server or on another WWW server on a public network, the content data is sent to the user's terminal via the public network in order to display the content data on the user's terminal.

On the other hand, according to the first embodiment of the invention, it is identification information about the content data that is sent from the bulletin board system server 121 to the user's terminal 111 via the public network 102, not the content data itself. Since the content data viewed by the user is stored in the HDD recorder 113 on the home network 101 to which the terminal 111 belongs, the content data itself is not sent and received via the public network 102.

For the hyperlink on the bulletin board system which implements the embodiment like this, it may be expressed by “anydevice@localnetwork/TVProgramTitle/20050708”, for example.

In the example above, “anydevice@localnetwork” means a storage device on a local network to which a user's terminal belongs. “/TVProgramTitle/20050708” indicates identification information of content data (a TV program named “TV ProgramTitle” broadcast on Jul. 8, 2005). In addition, “TVProgramTitle” may be expressed in various expression modes described above, including TV program information used by the EPG, VIDEO Plus+ numbers, content IDs, names of broadcasting stations, etc.

The terminal 111 acquires identification information of content data from the hyperlink, and retrieves that content data from the home network 101 to which the terminal belongs. The detailed operation will be described later.

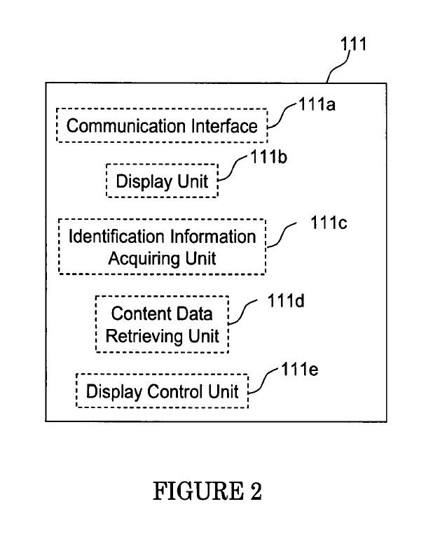

As shown in FIG. 2, the terminal 111 has a communication interface 111a which sends and receives data between a storage device on the home network 101 and a server on the public network 102, a display unit 111b which displays the bulletin board distributed by a bulletin board system server, an identification information acquiring unit 111c which acquires identification information of content data from the bulletin board system server, a content data retrieving unit 111d which retrieves content data from the HDD recorder 113 on the home network 101, and a display control unit 111e which provides the retrieved content data to the television set 112 and presents (displays) it thereon.

As described above, it is the configuration of the network system according to the first embodiment of the invention.

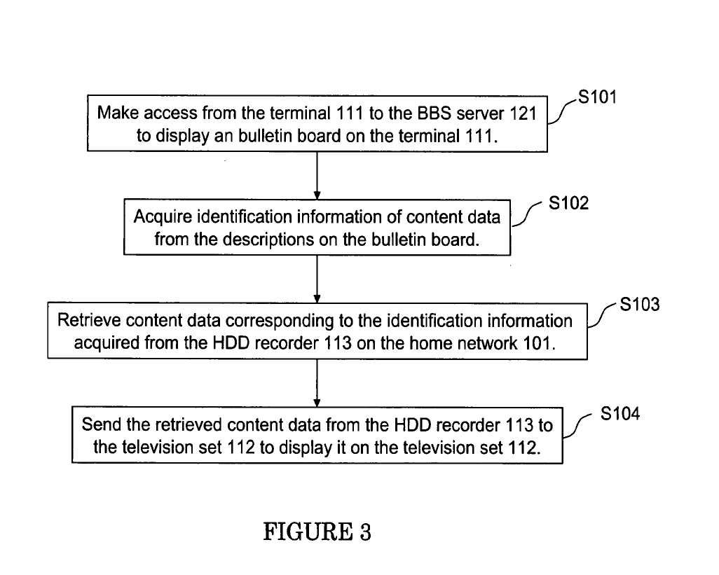

Next, the operation of the network system according to the first embodiment of the invention will be described with reference to FIG. 1 to FIG. 3. FIG. 3 is a flow chart showing the operation of the terminal 111 according to the first embodiment of the invention. In the description below, the devices on the home network 101 will be described as they can communicate data with each other. Data communications on the home network 101 can be implemented in which for example, each of the devices on the home network 101 has an IP address and each of the devices uses the IP address as a destination to send and receive data such as a control message. In this case, for example, when the terminal 111 finds a storage device storing a TV program among the devices on the home network 101, the terminal 111 sends a request message to the devices on the home network 101 for requesting a response whether it is a storage device that stores a TV program by multicasting. One storage device sends a response message of positive acknowledgment, and then the following operation is done between the terminal and that storage device. It is the same for finding a display device.

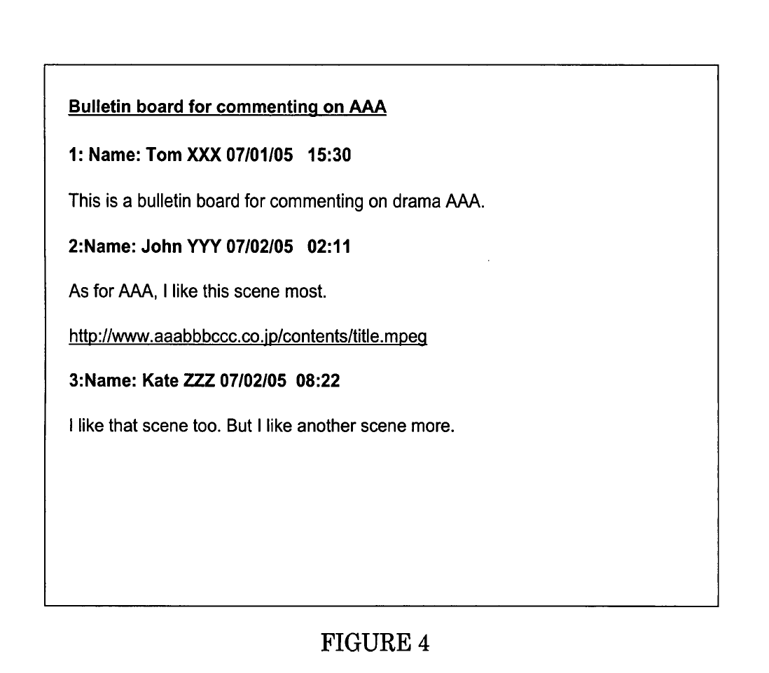

First, a user uses a Web browser and other schemes owned by the terminal 111 to display the bulletin board on the display unit 111b (Step S101). FIG. 4 shows exemplary display of the bulletin board. Displaying the bulletin board on the display unit 111b may be done by a Web browser, for example.

Subsequently, the identification information acquiring unit 111c of the terminal 111 acquires identification information of content data from the bulletin board system server 121 by the user's instruction (for example clicking) (Step S102). When Web site data provided by the bulletin board system server 121 is already stored in the memory of the terminal 111, identification information of content data may be acquired from data stored in the memory without having new access to the bulletin board system server 121.

When the identification information acquiring unit 111c of the terminal 111 acquires the identification information of content data in this manner, the content data retrieving unit 111d of the terminal 111 then retrieves content data corresponding to the acquired identification information from the HDD recorder 113 on the home network 101 (Step S103).

For a method of retrieving the content data corresponding to the acquired identification information from the HDD recorder 113 on the home network 101, for example, this method can be considered in which the HDD recorder 113 sends identification information of content data held by the HDD recorder 113 to the terminal 111 beforehand. More specifically, the identification information of content data sent from the HDD recorder 113 is stored as a content data list table in the memory in the terminal 111. Then, when the content data corresponding to particular identification information is to be retrieved, content data stored in the HDD recorder 113 may be retrieved based on this table.

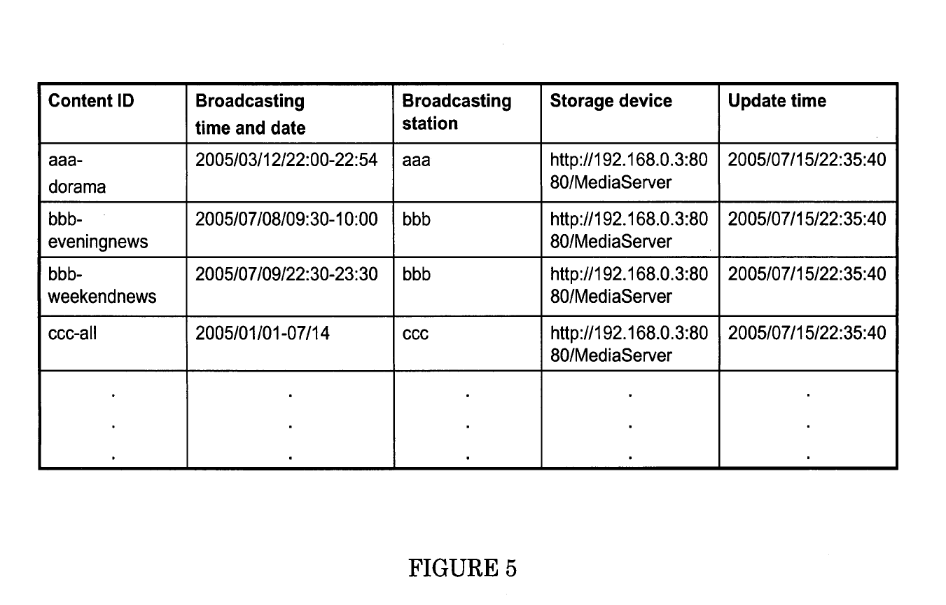

FIG. 5 shows an exemplary content data list table. Here, for every program title, the broadcasting time of the program, the broadcasting station, information about the stored storage device, and the latest time when the table is updated are stored. In the content data list table, content data may be stored as it is associated with identification information indicating that all the programs are stored that were broadcast at “ccc” broadcasting station on dates from “Jan. 1, 2005” to “Jul. 14, 2005” such as “ccc-all”. Desirably, the content data list table like this is periodically updated to store the latest descriptions all the time.

Separately from this, for example, this scheme may be done in which identification information of content data is sent from the terminal 111 to the HDD recorder 113 every time when content data is retrieved and the HDD recorder 113 is requested to answer whether to have the corresponding content data.

When there are multiple storage devices other than the HDD recorder 113, this scheme may be done in which the terminal 111 sends identification information of content data to the storage devices on the home network 101 by multicasting (or in turn) and receives an answer from each of the storage devices to retrieve the location of content data. When there are multiple storage devices on the home network 101, this scheme may be done in which a so-called “home directory server” is disposed which collectively manages content data stored in these storage devices and the content data retrieving unit 111d of the terminal 111 sends identification information of content data to this home directory server to answer the location of the corresponding content data.

Alternatively, this scheme may be done in which priorities are given to each of the storage devices and content data is in turn retrieved from the individual storage devices in accordance with the priorities.

Furthermore, when content data stored in each of the storage devices have differences in image quality because of different compression rates, for example, this scheme may be done in which content data of the highest image quality (a low compression rate) is retrieved.

Alternatively, this scheme may be done in which each of the retrieved items of content data is sent by the terminal 111 through the home network 101 to display it on the display unit 111b and a user is allowed to freely select content data.

Here, as described above, the HDD recorder 113 is considered to be a large capacity storage device. However, these cases can be considered in which content data cannot be found because only one part of a TV program is recorded, and in which content data cannot be found because a TV program was stored once but it was deleted from the HDD recorder 113. In these cases, the content data retrieving unit 111d receives an answer from the HDD recorder 113 that it does not have the corresponding content data. Then, the terminal 111 may display a message saying that content data cannot be displayed on the display unit 111b.

The content data retrieving unit 111d of the terminal 111 retrieves content data stored in the HDD recorder 113, and the display control unit 111e of the terminal 111 then sends the retrieved content data from the HDD recorder 113 to the television set 112 on the home network 101, and displays it thereon (Step S104).

More specifically, first, content data and a control message that instructs the destination (the television set 112) are sent from the display control unit 111e of the terminal 111 to the HDD recorder 113. In association therewith, to the television set 112, the display control unit 111e sends a control message that instructs the television set 112 to receive and display the content data sent from the HDD recorder 113.

In addition, content data may be directly sent from the HDD recorder 113 to the television set 112, but this scheme may be done in which content data to be sent is first received by the terminal 111 and it is forwarded to the television set 112. At this time, this scheme may be done in which content data is forwarded to the television set 112 while content data received at the display unit 111b is being displayed on the terminal 111, for example.

The description above is an example of so-called “third party setup” that the terminal 111 which is a third party sends a control message to the HDD recorder 113 and the television set 112. Separately from this, this scheme may be done to display content data on the television set 112 in which for example, the display control unit 111e of the terminal 111 sends to the television set 112 a control message that instructs the television set 112 to permit the HDD recorder 113 to send content data (the television set 112 pulls content data) and to receive and display it thereon.

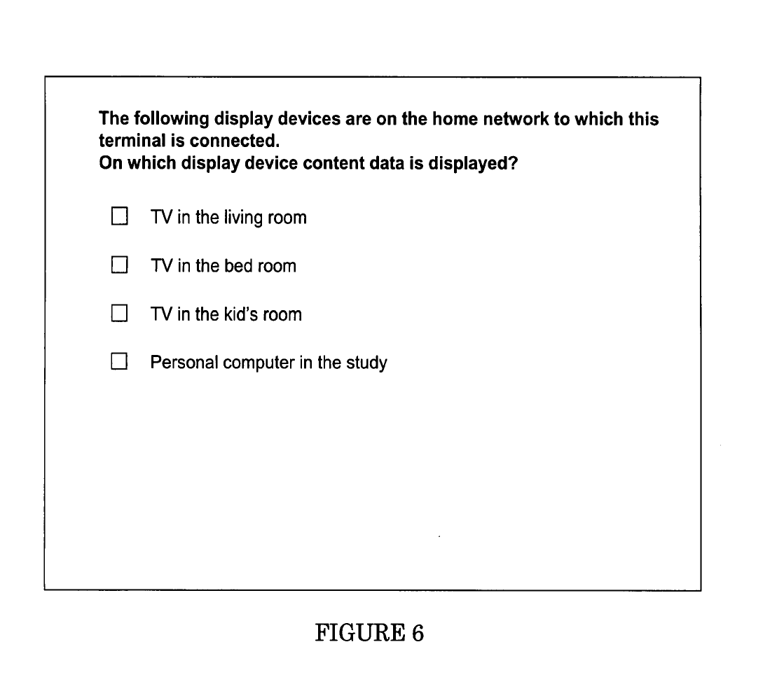

In addition, when there are multiple display devices which display content data, for example, this scheme may be done in which information about the multiple display devices on the home network 101 is stored in the terminal 111 beforehand and a user is allowed to select content data among them. More specifically, this scheme may be done in which a screen is displayed on the display unit 111b of the terminal 111, the screen allows a user to select display devices as shown in FIG. 6, for example, and content data is displayed on the display device selected by the user on this screen.

In addition, in the description above, in sending content data from the HDD recorder 113 to the television set 112, content data replayed at the HDD recorder 113 may be sent to the television set 112 and displayed on the television set 112. However, when the television set 112 has a function that replays content data, content data may be replayed at the television set 112. Furthermore, when content data stored in the HDD recorder 113 is forwarded to the television set 112 through the terminal 111, this scheme may be done in which content data is replayed at the terminal 111 and the replayed content data is forwarded to the television set 112 and displayed thereon.

As described above, content data stored in the HDD recorder 113 is sent to the television set 112 through the home network 101 and displayed thereon, and thus a user can view that content data. At this time, it is identification information of content data that is sent and received between the bulletin board system server 121 and the terminal 111 via the public network 102, and content data itself is not sent and received via the public network 102. Therefore, as described above, such a problem will not occur that content data cannot be sent and received via the public network because the capacity of content data exceeds the capacity permitted to be sent and received via the public network, for example.

As described above, according to the network system including the terminal 111 of the first embodiment, the terminal 111 can acquire identification information of content data from the bulletin board system server 121 connected to the public network 102, and allows content data stored in the storage device (the HDD recorder 113) on the home network 101 to be displayed on the television set 112 through the home network 101 based on the identification information of content data. Therefore, even though content data cannot be sent and received via the public network because of the types and the capacity of content data, a user can easily view content data.

In addition, in the embodiment described above, content data is considered to be displayed on the television set 112 by the instruction from the terminal 111. However, it may be displayed on the display unit 111b of the terminal 111. In this case, first, the terminal 111 permits the HDD recorder 113 to send content data retrieved by the content data retrieving unit 111d to the terminal 111. Then, the terminal 111 may receive content data sent from the HDD recorder 113, and may display it on the display unit 111b.

In addition, in the embodiment described above, content data is retrieved from the HDD recorder 113 connected to the terminal 111 via the home network 101. However, when content data is also stored in the memory in the terminal 111 along with identification information, the content data retrieving unit 111d may search the memory to retrieve content data.

In addition, in the embodiment described above, the implementation is described in which identification information of content data is acquired from the bulletin board system server as the WWW server. However, the WWW server may not be the bulletin board system server. More specifically, for example, even though a server offers a Web site that not allow anyone to post messages (for example, a homepage having no bulletin board system), identification information of content data may be acquired from a hyperlink to view that content data when identification information of content data is described in the hyperlink format.

In addition, in the embodiment described above, content data is the broadcast TV program, and the storage device is the HDD recorder. However, content data may be music and a still image, for example, and the storage device may be an AV device having memory, for example.

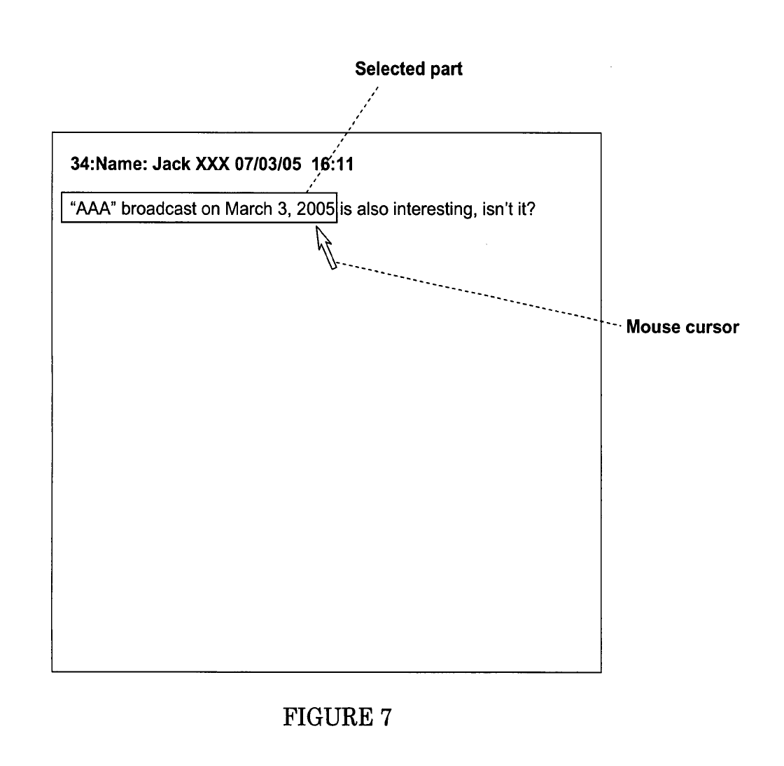

In addition, in the embodiment described above, identification information of content data is information expressed as a hyperlink on the bulletin board system, but it is not necessarily expressed as a hyperlink. For example, even though identification information is expressed as a simple character string on the bulletin board system, not a hyperlink, it is sufficient when the terminal 111 has a function to specify and select that character string. For the method thereof, for example, as shown in FIG. 7, this scheme may be done in which identification information of content data described on the bulletin board system is allowed to be selected by a mouse cursor and the identification information acquiring unit 111b acquires identification information of content data from that selected part.

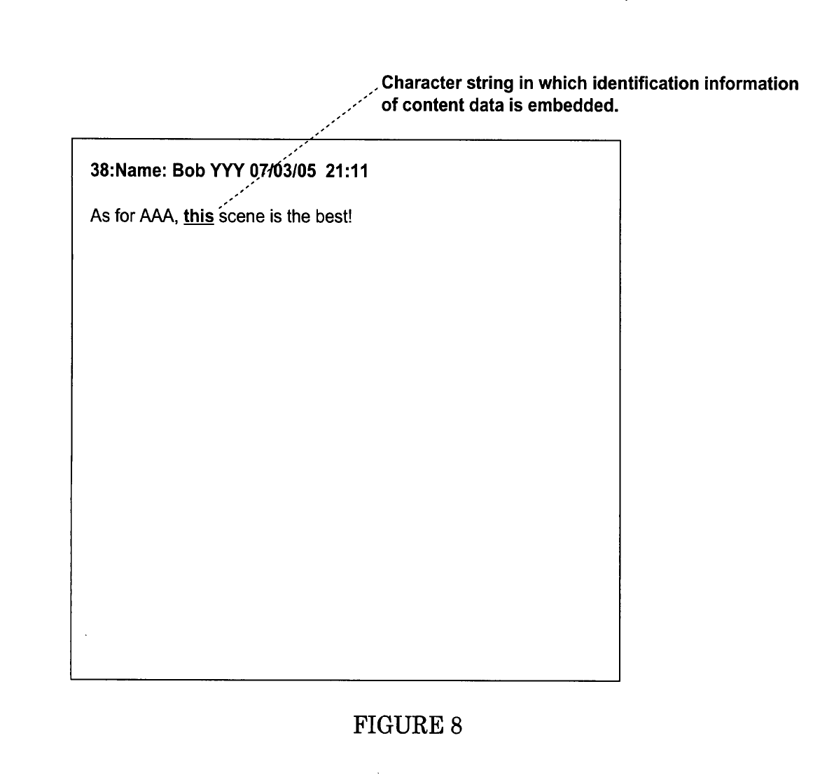

In addition, the hyperlink may not be in this form in which identification information of content data is directly described as a character string on the bulletin board system. For example, as shown in FIG. 8, identification information may be embedded in document data. In this case, identification information can be acquired by clicking the character string in the embedded part. Embedding identification information in document data in this manner can be implemented in such a way that for example, when HTML is used as a description language for document, description is done as “<A HRE F=“anydevice@localnetwork/TVProsramTitle/20050708”>Here</A>.

The terminal 111 can be implemented by using a general purpose computer unit, for example, as basic hardware. More specifically, the identification information acquiring unit 111c, the content data retrieving unit 111d, and the display control unit 111e can be implemented by allowing a processor mounted in the computer unit above to run a program product. At this time, the terminal 111 may be implemented in such ways that the program product is installed in the computer unit beforehand, or the program product is stored in a storage medium such as CD-ROM, distributed and then properly installed in the computer unit, or the program product is distributed through and installed. Furthermore, in addition to the functions described above, the terminal 111 may have a function as a television set or a function as a HDD recorder.

### Second Embodiment

In the first embodiment described above, the terminal 111 acquires identification information of content data from the bulletin board system server, and uses it to retrieve content data from the HDD recorder 113.

In a second embodiment, this implementation will be described in which in addition to identification information of content data, information for specifying a presentation method of content data is also acquired from the bulletin board system server 121 and content data is presented based on the information, including information for specifying one part of content data in order to display only that part, information for specifying a display rate (play speed) in displaying content data, information for specifying a language for use in the case of content data including a plurality of languages (for example, in the case of a TV program of sound multiplex broadcasting), and additional information displayed (inserted) in association with display of content data.

A network system according to the second embodiment of the invention is different in the network system according to the first embodiment in that an identification information acquiring unit 111c of a terminal 111 acquires identification information of content data as well as information for specifying the presentation method of content data described above, and a display control unit 111e controls a HDD recorder 113 and a television set 112 to present content data in accordance with the method.

First, an exemplary hyperlink is shown below which includes identification information of content data described above as well as information for specifying the presentation method of content data on the bulletin board system.

First, for a hyperlink which includes information for specifying the part of content data to be displayed for use to display only one part of content data, for example, it is sufficient to use the expression of “anydevice@localnetwork/TVProsramTitle/20050708/09300-093030”. The example above is an example that specifies a TV program of “TVProgramTitile” broadcast on Jul. 8, 2005 from 09:30 to 09:30:30. A display control unit 111f sends only the specified part in content data retrieved by a content data retrieving unit 111d from the HDD recorder 113 to the television set 112.

In addition, for a certain AV device, this case can be considered in which so-called “metadata” is defined that can specify a certain scene of content data, for example, for each type of devices or each of manufacturers. In this case, it may be possible to use the metadata to specify and display one part of content data.

For example, this case is considered in which a storage device named “DEF” made by “ABC manufacturer” stores TV programs in such a way that it assigns a number as metadata sequentially to each scene (for example, each column of a TV program or each news in a news program). In this case, for the hyperlink including information for specifying the part of content data to be displayed, for example, the expression of “ABC-DEF@localnetwork/TVProgramTitle/20050708/093000-100000/shot-number=3” can be used.

In the example above, “ABC-DEF@localnetwork” means the storage device of “DEF” made by “ABC manufacturer”, which is connected to a local network (that is, a home network 101) to which a terminal 111 belongs. Then, the expression of “TVProgramTitle/20050708/093000-100000/shot-number=3” specifies “the third shot (scene)” in the program of “TVProgramTitle” broadcast on Jul. 8, 2005 from 09:30 to 10:00:00. Then, the content data retrieving unit 111d of the terminal 111 retrieves the content data from the storage device of “DEF” made by “ABC manufacturer” on the home network 101, and the display control unit 111f sends only the specified part in the retrieved content data to the television set 112 and displays it thereon.

With this scheme, “metadata” defined by each of certain device types can be used to specify and display a certain scene.

Next, for the hyperlink including information for specifying the rate (play speed) to display content data, for example, it is sufficient to use the expression of “anydevice@localnetwork/TVProgramTitle/20050708/?speed=2”. The example above is an example that specifies a TV program of “TVProgramTitile” broadcast on Jul. 8, 2005 to be displayed at a speed twice the normal speed. The display control unit 111f sends the content data retrieved by the content data retrieving unit 111d from the HDD recorder 113 to the television set 112, controls the HDD recorder 113 to play and display that content data twice the normal speed.

Next, for the hyperlink including information for specifying a language to be used when content data has multiple languages (for example, in the case of a TV program of sound multiplex broadcasting), for example, it is sufficient to use the expression of “anydevice@localnetwork/TVProgramTitle/20050708/?audio=sub”. The example above is an example that specifies a TV program of “TVProgramTitile” broadcast on Jul. 8, 2005 to be outputted at subvoice-grade. The display control unit 111f sends and outputs the part corresponding to subvoice-grade in the content data retrieved by the content data retrieving unit 111d from the HDD recorder 113 to the television set 112.

Next, for the hyperlink including additional information to be inserted when content data is displayed, for example, it is sufficient to use the expression of “anydevice@localnetwork/TVProgramTitle/20050708” described above, and to use the expression of “<tt=text “I like this actor in this scene the best” content URI=“anydevice@localnetwork/TVProgramTitle/20050708” begin=“09:30:00” duration=“30:00” location=“(XXX, YYY)” medium=“arrow”/>” with HTML as a document description language.

In the description above, for the hyperlink, “anydevice@localnetwork/TVProgramTitle/20050708” is assigned to the user's comment, “I like this actor in this scene the best”. The following descriptions, “begin=“09:30:00”, duration=“00:00:30”, location=“(XXX, YYY)”, and medium=“arrow”, express that when this content data is displayed, an arrow as additional information needs to be displayed at the location on the display screen (XXX, YYY) for 30 seconds from 09:30:00.

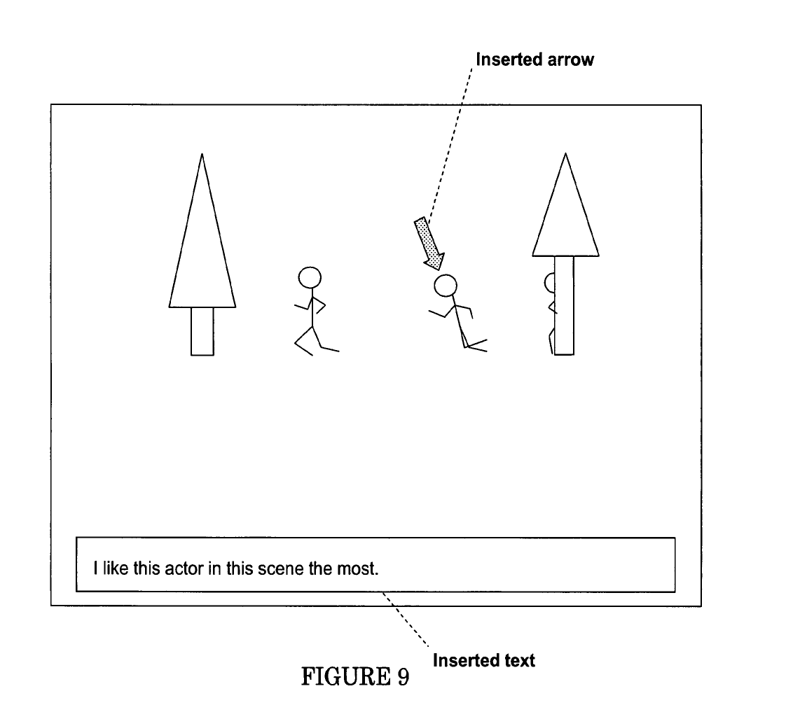

The identification information acquiring unit 111c of the terminal 111 acquires the identification information of content data (“/TVProgramTitle/20050708”) as well as additional information to be inserted, including text (“I like this actor in this scene the best”), symbol information (“medium=“arrow””) to be displayed, insertion location information (“location=“(XXX, YYY)””), and insertion time information (““begin=“09:30:00” duration=“00:00:30””). Then, when the display control unit 111e sends content data from the HDD recorder 113 to the television set 112 and displays it thereon, the display control unit 111e controls the HDD recorder 113 and the television set 112 to insert these items of additional information into content data and display them. FIG. 9 shows an example that additional information is inserted to content data and displayed it.

In addition, additional information may be inserted into content data at the HDD recorder 113, or may be at the television set 112. When it is inserted at the HDD recorder 113, the display control unit 111e first sends additional information to the HDD recorder 113, and allows the HDD recorder 113 to create content data into which additional information is inserted. Subsequently, it sends the created content data to the television set 112 to display it. On the other hand, when it is inserted at the television set 112, the display control unit 111e first allows the HDD recorder 113 to send content data to the television set 112. In association therewith, the display control unit 111e sends additional information to the television set 112, and sends a control message that instructs additional information to be inserted into the content data sent from the HDD recorder 113 and to be displayed. In response thereto, the television set 112 inserts additional information into the content data sent from the HDD recorder 113 and displays it.

As described above, according to the network system including the terminal 111 of the second embodiment of the invention, the terminal 111 acquires the identification information of content data as well as information for specifying the presentation method of content data from the bulletin board system server 121. Therefore, content data can be viewed in accordance with the presentation method of content data intended by a user who has posted a message on the bulletin board system.

### Third Embodiment

In the first embodiment, the implementation is described in which the terminal 111 acquires identification information of content data from the bulletin board system server 121 to retrieve the corresponding content data from the HDD recorder 113. In a third embodiment, an implementation will be described in which a terminal 111 sends identification information of content data stored in a HDD recorder 113 to a bulletin board system server 121.

More specifically, the first embodiment is the case in which the user of the terminal 111 views content data based on the identification information of content data described on the bulletin board, whereas in the third embodiment is an implementation in which a user of the terminal 111 conversely posts identification information of content data on a bulletin board.

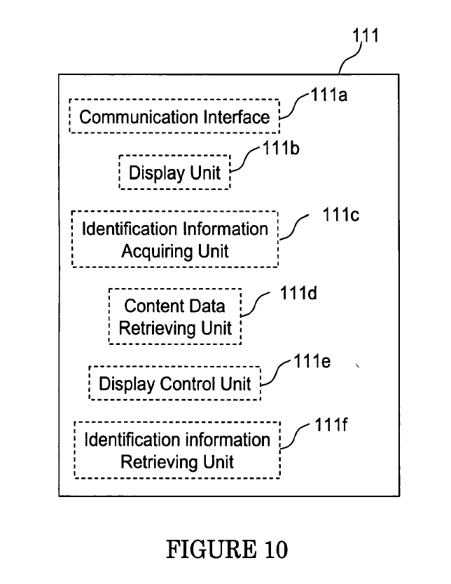

In the third embodiment, as shown in FIG. 10, the terminal 111 further has an identification information retrieving unit 111f which retrieves identification information of content data stored in the HDD recorder 113.

Here, identification information of content data to be posted on the bulletin board is considered to correspond to content data displayed on a display unit 111b of the terminal 111. The content data is considered to be stored in the HDD recorder 113.

In this case, the identification information retrieving unit 111f first sends to the HDD recorder 113 a message that inquires about identification information of content data sent from the HDD recorder 113 to the terminal 111.

The HDD recorder 113 receives the inquiry message, and sends the identification information of content data being sent to the terminal 111 to the terminal 111. Then, the terminal 111 receives it, and sends it to the bulletin board system server 121 (writes it on the bulletin board).

More specifically, suppose a user wants to post a comment on a program on the bulletin board system while he/she is viewing content data stored in the HDD recorder 113 (TV program) on the terminal 111. At that occasion, the user pauses on the TV program, or marks it by an electronic bookmark. Subsequently, the identification information retrieving unit 111f inquires the HDD recorder 113 about identification information of the paused or marked TV program, and thus retrieves the identification information out of the HDD recorder 113.

At this time, this scheme may be done in which the terminal 111 allows an application for displaying a TV program to work together with an application of a browser for displaying the bulletin board system, and the identification information retrieving unit 111f acquires the identification information from the HDD recorder 113 by taking a cue to drag and drop a certain scene of the TV program displayed on the application for displaying the TV program onto the browser.

When the identification information retrieving unit 111f acquires the desired identification information of content data, the terminal 111 modifies the acquired identification information to the hyperlink of “anydevice@localnetwork/TVProgramTitle/20050708”, for example, and sends it to the bulletin board system server 121 via a communication interface 111a.

In addition, at this time, this scheme may be done in which information for specifying the presentation method of content data such as information for specifying the part to be displayed in that content data is also included in the hyperlink and sent it along with the identification information of content data retrieved by the identification information retrieving unit 111f. More specifically, in the case in which content data is a TV program, for example, when it is desired to display only a certain scene in the TV program, information at the point in time when paused or marked by the electronic bookmark (for example, a predetermined point in time before and after the pause is made) is sent as the hyperlink of “anydevice@localnetwork/TVProgramTitle/20050708/093000-093030”, as described above.

In addition, when content data stored in the HDD recorder 113 is displayed on the television set 112, not on the display unit 111b of the terminal 111, this case can be considered in which a comment on that content data is desired to be posted on the bulletin board displayed on the terminal 111. In this case, this scheme may be done in which the identification information retrieving unit 111f sends to the HDD recorder 113 a message that inquires about identification information of content data sent from the HDD recorder 113 to the television set 112. Alternatively, this scheme may be done in which the identification information retrieving unit 111f sends to the television set 112 a message that inquires about identification information of content data now being displayed to permit the television set 112 to retrieve the identification information from the HDD recorder 113 and to answer it.

As described above, as the network system including the terminal 111 according to the third embodiment of the invention, desired identification information of content data is retrieved from the HDD recorder 113 storing content data, and it is allowed to be sent to the bulletin board system server 121. Therefore, it is made possible that the user of the bulletin board system specifies and views content data without sending and receiving content data itself with the bulletin board system server 121.

### Fourth Embodiment

In the first embodiment, the terminal 111 sends and receives data with the HDD recorder 113 and the television set 112 through the home network 101.

In a fourth embodiment, an implementation will be described in which a terminal which displays a bulletin board system is a mobile terminal and data communications between the mobile terminal and a HDD recorder and between the mobile terminal and a television set are done via a public network.

In recent years, a mobile terminal such as a cellular telephone has highly advanced functions, and such technology has been developed that can browse Web sites in the mobile terminal as well. However, the mobile terminal has a feature of a small display in order to carry it easily. For example, it is not suitable for the purpose of displaying a TV program in high image quality and of inserting and displaying a comment by another user on a TV program being displayed.

Then, in the fourth embodiment of the invention, an implementation will be described in which a bulletin board is displayed on the mobile terminal, whereas content data described on the bulletin board system is displayed on a display device having a larger screen than that of the mobile terminal, such as a television set on a home network

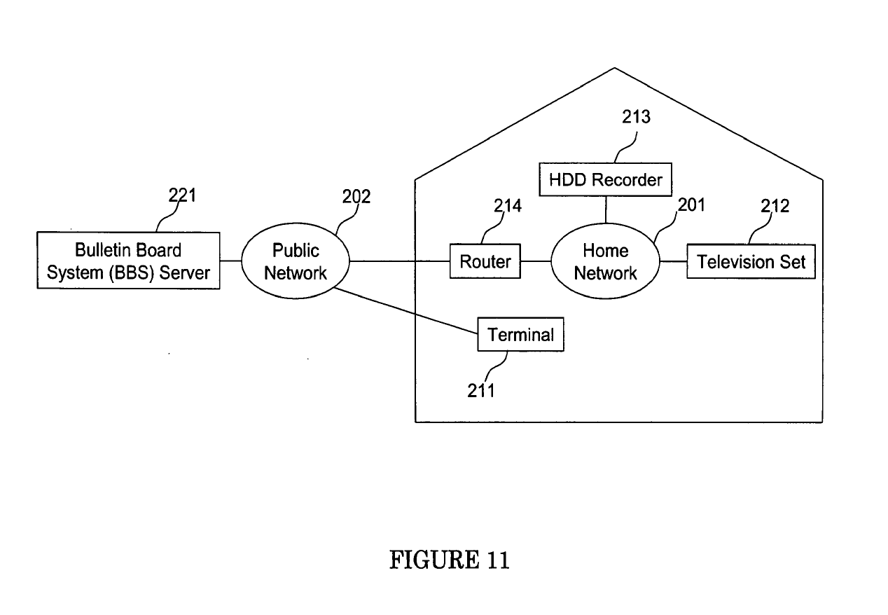

FIG. 11 is a block diagram showing a network system including an information processing terminal (hereinafter, called a terminal) according to the fourth embodiment of the invention.

In the network system according to the fourth embodiment, a television set 212 is connected to a HDD recorder 113 through a home network 201 which is a local network. In addition, the home network 201 is connected to a public network 202 through a router 214, and a bulletin board system server 221 is connected to a public network 202. In the embodiment, the terminal 211 is connected to the public network 202, and the television set 212 and the HDD recorder 213 on the home network 201 send and receive data via the public network 202.

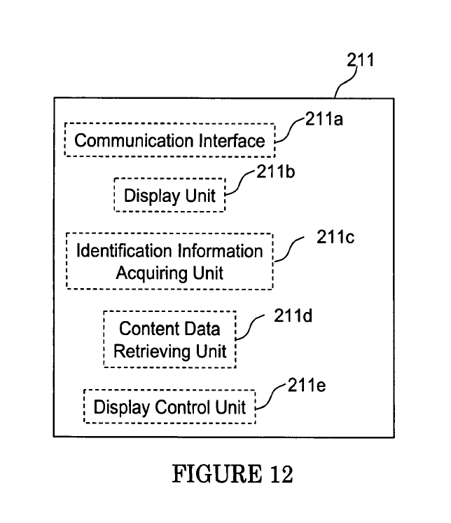

Here, as shown in FIG. 12, the terminal 211 has a communication interface 211a which sends and receives data between a storage device connected to the home network 201 via the public network 202 and a server on the public network 202, a display unit 211b which displays the bulletin board, an identification information acquiring unit 211c which acquires identification information of content data from the bulletin board system, a content data retrieving unit 211d which retrieves content data from the HDD recorder 213 on the home network 201, and a display control unit 211e which sends the retrieved content data to the television set 212 and displays it thereon.

Next, the operation of the network system according to the fourth embodiment of the invention will be described with reference to FIGS. 11 and 12.

First, a user uses a Web browser and other schemes owned by the terminal 211 to display the bulletin board on the display unit 211b of the terminal 211.

Subsequently, the identification information acquiring unit 211c acquires identification information of content data from the bulletin board system server 221 by an instruction done by the user clicking a hyperlink on the bulletin board system, for example. In addition, when data of a Web site of the bulletin board system provided by the bulletin board system server 221 is already stored in the memory (not shown in FIGS. 11 and 12) in the terminal 211, identification information of content data may be acquired from data stored in the memory in the terminal 211 without having new access to the bulletin board system server 221.

When the identification information acquiring unit 211c of the terminal 211 acquires the identification information of content data in this manner, the content data retrieving unit 211d then retrieves content data corresponding to the acquired identification information of content data from the HDD recorder 213 on the home network 201.

More specifically, first, the terminal 211 sends to the HDD recorder 213 a message that requests permission to have access via the public network 202. For permission of access, this scheme may be done in which for example, a user ID and a password are set to a user or the terminal to be authorized to have access to the HDD recorder 213 beforehand and access is permitted when the valid user ID and password are used to request access.

Alternatively, with no direct communications done with the HDD recorder 213 for permission of access, this scheme may be done in which on the home network 201, a management terminal (for example, a home gateway) is disposed which manages whether to permit access to the home network 201 via the public network 202, the terminal is first authorized by the management terminal, and the terminal is then permitted to send and receive data with the devices on the home network 202.

Alternatively, this scheme may be done in which some type of server exists on the Internet (a server on the home network 101 or a server that is authorized to connect thereto) and this server serves as the same function as that of the management terminal above. At this time, protocols between the mobile terminal and the management terminal (or the server) may be different from protocols between the management terminal (or the server) and the HDD recorder 213.

When access from the terminal 211 to the HDD recorder 213 is authorized, the content data retrieving unit 211d of the terminal 211 then retrieves the content data corresponding to the acquired identification information of content data from the HDD recorder 213.

For the method of retrieving content data from the HDD recorder 213 on the home network 201, this scheme may be done in which for example, the identification information of content data to be retrieved is sent to the HDD recorder 213, and the HDD recorder 213 answers whether to store the content data corresponding to the identification information.

When the content data retrieving unit 211d of the terminal 211 retrieves content data stored in the HDD recorder 213, the display control unit 211e of the terminal 211 then controls the HDD recorder 213 and the television set 212 to output the retrieved content data to the television set 212 on the home network 201 and display it thereon.

More specifically, first, the display control unit 211e sends to the HDD recorder 213 via the public network 202 a control message to send content data to the television set 212 instructs the destination In association therewith, the display control unit 211e sends to the television set 212 via the public network 202 a control message that instructs the television set 212 to receive and display content data sent from the HDD recorder 213 through the home network 201.

As described above, content data stored in the HDD recorder 213 is sent to the television set 212 through the home network 201 and displayed thereon. Therefore, the user can view that content data on the television set 212. At this time, it is identification information of content data or a control message that instructs the operation of the device that is sent and received between the bulletin board system server 221 and the terminal 211 via the public network 202 or between the device on the home network 201 and the terminal 211 via the public network 202. Content data itself is not sent and received via the public network 202. Therefore, such a problem will not occur that content data cannot be sent and received via the public network because the capacity of content data exceeds the capacity to be sent and received via the public network, as described above.

As described above, according to the network system including the terminal 211 of the fourth embodiment of the invention, even though the terminal 211 is not connected to the home network 201, content data can be viewed by using the television set 212 on the home network 201 without sending and receiving content data via the public network 202.

In addition, in the embodiment described above, the terminal 211 sends the control message to the HDD recorder 213 and other devices via the public network 202. However, the control message may be sent via a public telephone line network, for example, different from the public network 202. For example, this scheme may be done in which the management terminal for the server on the Internet) described above is a Web server, it is allowed to issue a control command to the HDD recorder 213 and other devices by CGI (Common Gateway Interface) or some types of scripts, and the mobile terminal sends a command to this web server (commands for Web service etc.).

The invention is not limited to the embodiments above as unchanged, which can be implemented by modifying components with in the scope not deviating from the teachings at implementing stages. In addition, a plurality of the components disclosed in the embodiments is properly combined to form various inventions. For example, some of the components may be omitted from all the components shown in the embodiments. Furthermore, the components shown in different embodiments may be properly combined.

What is claimed is:

1. An information processing terminal connected to a WWW (World Wide Web) server via a public network and connected to a storage device through a local network, the storage device storing content data including image information or sound information with identification information of the content data, the information processing terminal comprising:
an acquiring unit configured to acquire the identification information of the content data from a character string that is distributed by the WWW server via the public network;
a retrieving unit configured to retrieve the content data, which corresponds to the identification information acquired by the acquiring unit, from the storage device through the local network; and
a presenting unit configured to present the content data retrieved by the retrieving unit.

2. An information processing terminal connected to a WWW (World Wide Web) server via a public network and connected to a storage device and a presentation device through a local network, the storage device storing content data including image information or sound information with identification information of the content data and the presentation device presenting the content data, the information processing terminal comprising:
an acquiring unit configured to acquire the identification information of the content data from a character string that is distributed by the WWW server via the public network;
a retrieving unit configured to retrieve the content data, which corresponds to the identification information acquired by the acquiring unit, from the storage device through the local network; and
a controlling unit configured to transfer the content data retrieved by the retrieving unit to the presentation device through the local network.

3. The information processing terminal according to claim 1, wherein the acquiring unit is configured to acquire the identification information of the content data from the character string of a hyperlink that is distributed by the WWW (World Wide Web) server.

4. The information processing terminal according to claim 1, wherein the WWW (World Wide Web) server is a BBS (Bulletin Board System) server.

5. The information processing terminal according to claim 1,
wherein the acquiring unit is configured to acquire the identification information of the content data as well as information for specifying a presentation method of the content data from the WWW (World Wide Web) server; and
wherein the presenting unit is configured to present the content data retrieved by the retrieving unit in accordance with the presentation method acquired by the acquiring unit.

6. The information processing terminal according to claim 2,
wherein the acquiring unit is configured to acquire the identification information of the content data as well as information for specifying a presentation method of the content data from the WWW (World Wide Web) server; and
wherein the controlling unit is configured to control the presentation device to present the transferred content data in accordance with the acquired presentation method.

7. The information processing terminal according to claim 2,
wherein the acquiring unit is configured to acquire the identification information of the content data as well as information for specifying a part to be presented in the content data from the WWW (World Wide Web) server; and
wherein the presenting unit is configured to present the specified part in the content data retrieved by the retrieving unit.

8. The information processing terminal according to claim 1,
wherein the acquiring unit is configured to acquire the identification information of the content data as well as information for specifying a speed to present the content data from the WWW (World Wide Web) server; and
wherein the presenting unit is configured to present the content data retrieved by the retrieving unit at the specified speed.

9. The information processing terminal according to claim 1,
wherein the acquiring unit is configured to acquire the identification information of the content data as well as information for specifying a language for use in presenting the content data from the WWW (World Wide Web) server; and
wherein the presenting unit is configured to present the content data retrieved by the retrieving unit in the specified language.

10. The information processing terminal according to claim 1,
wherein the acquiring unit is configured to acquire the identification information of the content data as well as additional information to be presented in association with presenting the content data from the WWW (World Wide Web) server; and
wherein the presenting unit is configured to present the content data retrieved by the retrieving unit as well as the additional information.

11. The information processing terminal according to claim 1, further comprising:
an identification retrieving unit configured to retrieve the identification information of the content data presented at the presenting unit from the storage device; and
a sending unit configured to send the identification information retrieved by the identification retrieving unit to the WWW (World Wide Web) server.

12. The information processing terminal according to claim 2, further comprising:
an identification retrieving unit configured to retrieve the identification information of the content data presented at the presentation device from the storage device; and
a sending unit configured to send the identification information retrieved by the identification retrieving unit to the WWW (World Wide Web) server.

13. An information processing method of an information processing terminal connected to a WWW (World Wide Web) server via a public network and connected to a storage device through a local network, the method comprising:
acquiring identification information of content data including image information or sound information from a character string that is distributed by the WWW server via the public network;
retrieving the content data, which corresponds to the acquired identification information, from the storage device through the local network, the storage device storing the content data with the identification information of the content data; and
presenting the retrieved content data.

14. A computer-readable medium connected to a WWW (Word Wide Web) server via a public network and connected to a storage device through a local network, the computer-readable medium including computer-executable instructions, the instructions for:
acquiring identification information of content data including image information or sound information from a character string that is distributed by the WWW server via the public network;
retrieving the content data, which corresponds to the acquired identification information, from the storage device through a local network, the storage device storing the content data with the identification information of the content data; and
presenting the retrieved content data.
